(19) United States
(12) Patent Application Publication
(10) Pub. No.: US 2006/0249938 A1
(43) Pub. Date: Nov. 9, 2006

(54) Gas generator for air bag

(75) Inventors: Naoki Matsuda, Tatsuno-Shi (JP); Atsushi Hatomoto, Tatsuno-Shi (JP); Mikio Yabuta, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/402,832

(22) Filed: Apr. 13, 2006

Related U.S. Application Data
(60) Provisional application No. 60/673,370, filed on Apr. 21, 2005.

(30) Foreign Application Priority Data
Apr. 15, 2005 (JP) 2005-118275

(51) Int. Cl. B60R 21/26

(52) U.S. Cl. 280/736; 280/741

(57) ABSTRACT

The present invention relates to a gas generator for an air bag including a single cylindrical housing charged with a pressurized gas and at least one ignition device mounted to the cylindrical housing, the cylindrical housing having a reduced diameter portion formed by an annular convex portion protruding inward, the reduced diameter portion having a single first gas discharge port sealed by a rupturable plate, the reduced diameter-portion, which has the first gas discharge port, being surrounded by a cylindrical diffuser portion having a plurality of second gas discharge ports, and an outer diameter including the part surrounded by the diffuser portion approximates an outer diameter of the cylindrical housing.

This nonprovisional application claims priority under 35 U.S.C. §119(a) on Patent Application No. 2005-118275 filed in Japan on 15 Apr. 2005 and 35 U.S.C. §119(c) on U.S. Provisional Application No. 60/673370 filed on 21 Apr. 2005, which are incorporated by reference.

### BACKGROUND OF THE INVENTION

1. Field of the Invention

The present invention relates to a gas generator for an air bag.

2. Description of the Related Art

In a dual type gas generator which allows arbitrary output adjustment in accordance with the impact generated upon collision, a plurality of ignition/activation mechanisms which are activated independently of each other must be provided. Accordingly, a structure which prevents one of the ignition/activation mechanisms from affecting the other ignition/activation mechanism must be provided.

U.S. Pat. No. 5,794,973 discloses a gas generator in which a pressurized gas is disposed in the interior of a housing and ignition devices are disposed on both ends of the housing. A part having a small diameter is formed in a central portion of the housing, and a gas discharge port sealed by a rupturable plate is provided in one location of the small diameter part. Further, a cup-form diffuser is provided so as to cover the gas discharge port. The diffuser has a gas nozzle on a peripheral wall portion thereof, and is therefore attached so as to protrude from the housing.

U.S. Pat. No. 5,582,428 discloses a gas generator in which two chambers 16, 18 containing a pressurized medium are attached via a common connecting ring 30. The chambers 16, 18 are sealed by respective rupturable plates 42, 44 disposed in proximity to each other and directly opposite each other such that a central chamber 32 is separated from the chambers 16, 18. A heating device 22 is attached to each chamber 16, 18, and the activation timing of the respective heating device 22 is varied according to the intensity of the impact. Upon activation of the heating apparatus 22, the internal pressure of the chamber 16 or 18 rises, causing the rupturable plate 42 or 44 to rupture. A plurality of gas discharge holes 46 are formed in the ring 30.

In U.S. Pat. No. 3,961,806, two chambers 70, 72 containing a pressurized gas are formed by a partition wall 74 having a small hole 78 (in the drawings, the small hole 78 is disposed in the center of the partition wall 74). An explosive 68 is disposed on a rupturable plate 66 of the front chamber 70, and the rupturable plate 66 is ruptured by an impact. Meanwhile, a propellant 80 is disposed in a central part of the rear chamber 72, and additional gas is generated upon combustion of the propellant 80, thereby raising the pressure of the rear chamber 72. As a result, gas flows into the front chamber 70 through the small hole 78.

### SUMMARY OF THE INVENTION

The present invention relates to a gas generator for an air bag including a single cylindrical housing charged with a pressurized gas and at least one ignition device mounted to the cylindrical housing,

the cylindrical housing having a reduced diameter portion formed by an annular convex portion protruding inward thereof,

the reduced diameter portion having a single first gas discharge port sealed by a rupturable plate,

the reduced diameter portion, which has the first gas discharge port, being surrounded by a cylindrical diffuser portion having a plurality of second gas discharge ports, and

an outer diameter including the part surrounded by the diffuser portion approximates an outer diameter of the cylindrical housing.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows an axial sectional view of a gas generator for an air bag;

FIG. 2(a) shows an axial sectional view of another gas generator for an air bag, and FIG. 2(b) shows a partial sectional view illustrating an operation of FIG. 2(a); and

FIG. 3(a) shows an axial sectional view of another gas generator for an air bag, and FIG. 3(b) shows a partial sectional view illustrating an operation of FIG. 3(a).

### DETAILED DESCRIPTION OF THE INVENTION

One aspect of the present invention is to provide a gas generator for an air bag having a substantially flat contour line in the axial direction of a gas generator housing and with no parts protruding axially outward, in which a gas charging operation can be performed easily and gas can be ejected radially upon activation, and also to provide a gas generator for an air bag in which activation of one ignition device does not affect activation of another ignition device.

The interior of the cylindrical housing is sealed tightly so that the pressurized gas can be charged and held therein. The axial cross-section of the cylindrical housing is circular, but may be elliptical or polygonal.

The ignition device may include an electric igniter alone, a combination of an electric igniter and a molded article of a gas generating composition, or a combination of these members and another member.

The reduced diameter portion is an annular convex portion (an annular concave portion when seen from the outer surface) which protrudes inward. As long as 75% or more of the reduced diameter portion in the circumferential direction (a proportion for the entire circumferential length as a reference) is formed by a continuous annular convex portion, the convex portion need not be formed in a part of the circumference. However, the entire circumferential direction (100% length of the circumferential direction) is preferably formed by a continuous annular convex portion.

The reduced diameter portion is preferably positioned in an axially central portion, but may be formed in a position which is offset toward either end side.

The reduced diameter portion may be formed by a method in which pressure is applied to the cylindrical housing from the outside to form an annular concave portion (groove portion). Alternatively, the cylindrical housing may be combined with a separate member having a smaller diameter.

The diffuser portion is cylindrical, and the outer diameter including the part surrounded by the diffuser portion approximates the outer diameter of the cylindrical housing (outer diameter surrounded by diffuser portion=housing outer diameter+diffuser portion thickness). Accordingly, the outer surface of the cylindrical housing and the outer surface of the diffuser portion form a substantially flush state essentially having no protrusions. Hence, in comparison with a gas generator having a radial protrusion, such as that described in U.S. Pat. No. 5,794,973, a mounting operation performed to house the air bag and gas generator in a module case is easy, and workability during storage and transportation is favorable.

The single first gas discharge port is provided in the reduced diameter portion, and the plurality of second gas discharge ports, which are disposed at equal intervals in the circumferential direction, are provided in the diffuser portion. Thus, the gas that is ejected through the first gas discharge port is ejected radially while moving in the circumferential direction, and therefore inflates the air bag evenly. Note that by adjusting the positions of the second gas discharge ports, the gas can be ejected in a specific direction.

Further, the interior of the cylindrical housing provides a single space, and hence there is no need to charge pressurized gas separately into two spaces, as in U.S. Pat. No. 5,582,428. Accordingly, only one pressurized gas charging operation is required.

The present invention further relates to the gas generator for an air bag, wherein, when two or more ignition devices are provided, at least one of the ignition devices accommodates, in a combustion housing having a plurality of the gas discharge ports, a gas generating agent and an electric igniter.

When two ignition devices are provided, the two devices may be activated simultaneously, one of the devices may be activated first and the other at a delay, or only one of the devices may be activated. Hence, when two ignition devices are provided, a combustion chamber housing may be provided for one of the ignition devices (the ignition device that may be activated at a delay) such that activation of the ignition device that may be activated first does not adversely affect activation of the ignition device that may be activated at a delay.

The present invention further relates to the gas generator for an air bag, including:

the cylindrical housing being partitioned into two spaces by an axially movable partition wall having a communication hole,

at least a first activated ignition device and a second activated ignition device being disposed in each of the two spaces, respectively

the partition wall moving in the axial opposite direction to the first activated ignition device upon the activation of the first activated ignition device disposed in one of the spaces so as to close the communication hole by coming in contact with a part of a fixing member disposed in the other space,

the partition wall moving in the axial opposite direction to the second activated ignition device upon the activation of the second activated ignition device disposed in the other space so as to open the communication hole.

In this invention, the fixed member denotes a wall or cup for partitioning the space accommodating the ignition device from the other spaces, which has a gas-transmitting hole.

In the gas generator of this invention, by providing a movable partition wall the following further functions (actions) and effects are obtained.

When the interior of the cylindrical housing forms a single space, the heat, shock wave, and so on generated upon activation of one of the ignition devices may come into contact with the other ignition device, causing erroneous activation of the other ignition device.

In the present invention, however, the partition wall moves to the axially opposite side (the side of the other ignition device) upon activation of one ignition device, thereby coming in contact with the fixed member disposed in the other space such that the communication hole in the partition wall is closed. As a result, the heat, shock wave, and so on do not come into contact with the other ignition device. Moreover, since the partition wall is capable of movement, it can be modified easily in response to various demands, unlike a fixed partition wall.

The present invention further relates to the gas generator for an air bag, wherein the partition wall is disposed between the reduced diameter portion of the cylindrical housing and the other ignition device.

The present invention further relates to the gas generator for an air bag, wherein the other ignition device accommodates a gas generating agent and an electric igniter in a combustion chamber housing having a plurality of gas holes,

the combustion chamber housing is the fixed member, and

the partition wall comes in contact with a wall surface of the combustion chamber housing having no gas holes.

The combustion chamber housing is a member for separating the ignition device from the other spaces, and may be a disk member which partitions the cylindrical housing radially, a cup-form member surrounding the ignition device, and so on. When the combustion chamber housing is a cup-form member, gas holes can be provided in desired positions of the peripheral surface and top surface. Preferably, however, a plurality of gas holes are provided in the peripheral surface and no gas holes are provided in the top surface. By having the combustion chamber housing function as the fixed member in this manner, activation of one ignition device can be prevented from affecting the other ignition device.

The present invention further relates to the gas generator for an air bag, including:

an axially movable first partition wall having a first communication hole and a fixed second partition wall having a second communication hole partitioning the cylindrical housing into a first space formed by the first partition wall and the cylindrical housing, a second space formed by the second partition wall and the cylindrical housing, and a third space formed by the first partition wall, the second partition wall and the cylindrical housing,

the first communication hole of the first partition wall and the second communication hole of the second partition wall being formed in positions which do not overlap axially,

at least one first ignition device and second ignition device being disposed respectively in the first space and the second space,

when the first ignition device disposed in the first space is activated, the first partition wall moving toward an axially opposite side, and when the first partition wall comes in contact with the second partition wall, the first communication hole and the second communication hole being closed, and

when the at least one second ignition device, which is disposed in the second space, being activated, the first partition wall, which contacts the second partition wall, moving toward an axially opposite side of the second partition wall thereby opening the first communication hole and the second communication hole.

In this invention, the third space exists between the movable first partition wall and the fixed second partition wall prior to activation, but following activation of the first ignition device, the first partition wall moves so as to become pressed against the second partition wall, thereby eliminating the third space. The first communication hole in the first partition wall and the second communication hole in the second partition wall are formed in positions which do not overlap axially, and hence at this time, the first communication hole is closed by the second partition wall surface, while the second communication hole is closed by the first partition wall surface. As a result, the heat, shock wave, and so on do not flow into the second ignition device side. Following activation of the second ignition device, the first partition wall moves to the opposite side of the second partition wall, thereby restoring the third space and securing a gas passage.

The present invention further relates to the gas generator for an air bag, wherein the reduced diameter portion of the cylindrical housing is an annular convex portion protruding inward which has two axially opposing inclined surface portions and a flat contour portion provided between the two inclined surface portions,

the first partition wall is disposed on the flat contour portion of the reduced diameter portion, the flat contour portion having a stopper portion for restricting axial movement of the first partition wall, and

the second partition wall is fixed to one of the inclined surface portions of the reduced diameter portion.

Upon activation of the second ignition device, the first partition wall moves axially to restore the third space. At this time, the third space is preferably formed to secure a gas passage, but when limitless movement of the first partition wall is permitted, the first gas discharge port may be blocked, conversely obstructing gas discharge. Hence, axial movement of the first partition wall is limited so that a gas discharge path can be secured reliably.

The gas generator for an air bag of the present invention is applicable to a gas generator which uses both pressurized gas and the combustion gas of a gas generating agent as media for inflating the air bag, and a gas generator which uses only pressurized gas. The gas generator for an air bag of the present invention may be used in various well-known forms such as a gas generator for an air bag for a driver side and a gas generator for an air bag for a front passenger side.

In the gas generator for an air bag of the present invention, no protrusions are formed on the outer surface of the cylindrical housing. Therefore, mounting in a module case is easy, and since there are no protrusions, the workability of storage and transportation operations is favorable.

In the gas generator for an air bag of the present invention, when two or more ignition devices are disposed separately, activation of one of the ignition devices does not adversely affect the other ignition device.

### EMBODIMENTS OF THE INVENTION

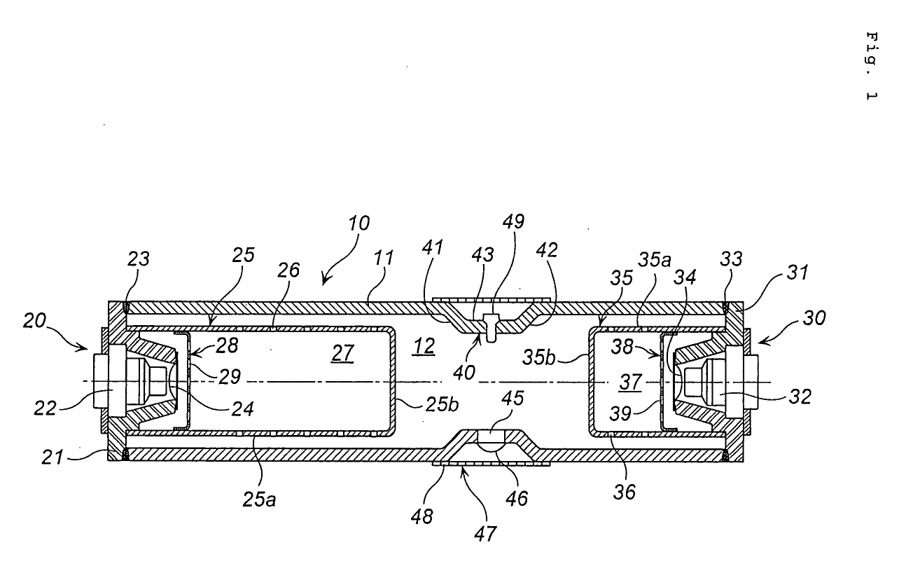

(1) Gas Generator of FIG. 1

FIG. 1 is an axial sectional view of a gas generator 10 of the present invention.

A cylindrical housing 11 has a circular cross-section in the radial direction and is formed from a pressure-resistant metal. A pressurized gas such as argon or helium is charged into a space 12 inside the cylindrical housing 11 (at a charging pressure of approximately 30,000 to 67,000 kPa).

A first ignition device 20 is mounted to an opening portion at one end side of the cylindrical housing 11. The first ignition device 20 includes an electric first igniter 22 and a molded article of a gas generating composition (not shown) which are accommodated within a combustion chamber housing 25.

The first igniter 22 is fitted into a boss 21 and attached to the opening portion at one end side of the cylindrical housing 11. A joint portion 23 between the cylindrical housing 11 and boss 21 is welded. An opening portion in the boss 21 is sealed by a first rupturable plate 24 such that the first rupturable plate 24 faces the first igniter 22.

The boss 21 including the first igniter 22 is surrounded by the cup-form first combustion chamber housing 25, and the interior of the first combustion chamber housing 25 forms a first combustion chamber 27. An opening portion of the first combustion chamber housing 25 is fitted onto a stepped portion of the boss 21. The first combustion chamber housing 25 has a plurality of first gas holes 26 in its peripheral surface 25a, although no first gas holes 26 are provided in a top surface 25b. Pressurized gas also exists inside the first combustion chamber housing 25.

A well-known molded article of a gas generating composition (not shown) is charged into the first combustion chamber 27, and a movable retainer 28 is disposed in the first combustion chamber 27 for adjusting the volume of the first combustion chamber 27 in accordance with the charged amount of the molded article of a gas generating composition and preventing the molded article of a gas generating composition from infiltrating between the peripheral surface of the boss 21 and the peripheral surface of the first combustion chamber housing 25. The retainer 28 is provided with a plurality of holes 29 allowing the transmission of heat and a shock wave generated upon activation of the first igniter 22.

A second ignition device 30 is mounted to an opening portion at the other end side of the cylindrical housing 11. The second ignition device 30 includes an electric second igniter 32 and a molded article of a gas generating composition (not shown) which are accommodated within a combustion chamber housing 35.

The second igniter 32 is fitted into a boss 31 and attached to the opening portion the other end side of the cylindrical housing 11. A joint portion 33 between the cylindrical housing 11 and boss 31 is welded. An opening portion in the boss 31 is sealed by a second rupturable plate 34 such that the second rupturable plate 34 faces the second igniter 32.

The boss 31 including the second igniter 32 is surrounded by the cup-form second combustion chamber housing 35, and the interior of the second combustion chamber housing 35 forms a second combustion chamber 37. An opening portion of the second combustion chamber housing 35 is fitted onto a-stepped portion of the boss 31. The second combustion chamber housing 35 has a plurality of second gas holes 36 in its peripheral surface 35a, although no second gas holes 36 are provided in a top surface 35b. Pressurized gas also exists inside the second combustion chamber housing 35.

A well-known molded article of a gas generating composition (not shown) is charged into the second combustion chamber 37, and a movable retainer 38 is disposed in the second combustion chamber 37 for adjusting the volume of the second combustion chamber 37 in accordance with the charged amount of the molded article of a gas generating composition and preventing the molded article of a gas generating composition from infiltrating between the peripheral surface of the boss 31 and the peripheral surface of the second combustion chamber housing 35. The retainer 38 is provided with a plurality of holes 39 allowing the transmission of heat and a shock wave generated upon activation of the second igniter 32.

A reduced diameter portion 40 is provided toward the second ignition device 30 side of the cylindrical housing 11. The reduced diameter portion 40 includes two axially opposing inclined surface portions 41, 42 and an annular convex portion having a flat contour portion 43 provided between the two inclined surface portions 41, 42. The reduced diameter portion 40 is formed around a circumference of the cylindrical housing 11.

A single first gas discharge port 45 is provided in the flat contour portion 43 of the reduced diameter portion 40, and the first gas discharge port 45 is sealed by a discharge port rupturable plate 46. The reduced diameter portion 40 including the first gas discharge port 45 is surrounded by a cylindrical diffuser portion 47 having a plurality of second gas discharge ports 48. The cylindrical diffuser portion 47 is welded at a contact surface with the cylindrical housing 11.

The outer diameter including the part surrounded by the diffuser portion 47 corresponds to the sum total of the outer diameter of the cylindrical housing 11 and the thickness of the diffuser portion 47, and hence, as shown in the drawing, the gas generator 10 has a substantially flat contour line in the axial direction of the cylindrical housing. The diffuser portion 47 is used to prevent pieces of the discharge port rupturable plate 46 from scattering. The diffuser portion 47 may be formed from wire mesh or the like, and hence a thickness of approximately 0.5 to 1.5 mm is sufficient.

The flat contour portion 43 has a gas charging hole that is closed by a pin 49. During assembly of the gas generator 10, gas is charged through gaps between the pin 49 and the gas charging hole into which the pin 49 is inserted. The flat contour portion 43 and pin 49 are then welded to seal the gas charging hole. By providing the gas charging hole closed by the pin 49 in the flat contour portion 43, the outer end portion of the pin 49 does not protrude onto the outer surface of the cylindrical housing 11.

Next, an operation of the gas generator 10 for an air bag will be described. A case in which the first igniter 22 is activated first and the second igniter 32 is activated at a delay will be described.

Upon activation of the first igniter 22, the first rupturable plate 24 ruptures, causing heat and a shock wave to flow into the first combustion chamber 27 so as to ignite and burn the first gas generating agent. High-temperature gas generated through combustion of the first molded article of a gas generating composition flows into the interior space 12 through the gas holes 26 in the first combustion chamber housing 25, thereby raising the pressure of the interior space 12.

This increase in the internal pressure of the interior space 12 causes the discharge port rupturable plate 46 to rupture, thereby opening the first gas discharge port 45. A mixed gas including the pressurized gas and high-temperature gas that are ejected through the first gas discharge port 45 moves through the reduced diameter portion 40 in a circumferential direction, passes through the diffuser portion 47, and is discharged radially through the second gas discharge ports 48 to inflate the air bag. During this process, the high-temperature gas flowing out of the first combustion chamber 27 is prevented from igniting and burning the second molded article of a gas generating composition by the second combustion chamber housing 35.

The second igniter 32 is activated at a slight delay, thereby rupturing the second rupturable plate 34. Heat and a shock wave then flow into the second combustion chamber 37 to ignite and burn the second molded article of a gas generating composition. The high-temperature gas that is generated through combustion of the second molded article of a gas generating composition flows into the interior space 12 through the gas holes 36 in the second combustion chamber housing 35, passes through the open first gas discharge port 46, and is then discharged radially through the second gas discharge ports 48 to further inflate the air bag.

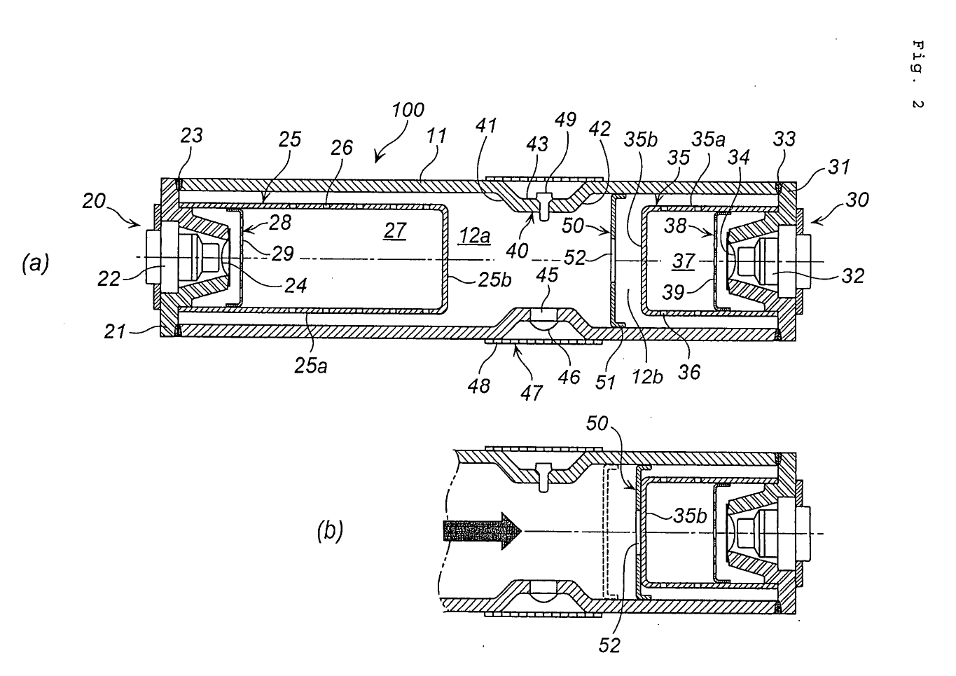

(2) Gas Generator of FIG. 2

FIG. 2(a) is an axial sectional view of a gas generator 100 of the present invention, and FIG. 2(b) is a partial sectional view illustrating an operation of the gas generator 100 in FIG. 2(a). FIG. 2 illustrates a similar structure to the gas generator 10 in FIG. 1, and therefore only different parts will be described. In FIG. 2, identical reference numerals to those used in FIG. 1 denote identical components.

The interior of the cylindrical housing 11 is partitioned into a first space 12a and a second space 12b by a disk-form partition wall 50 which is capable of axial movement. A circular communication hole 52 is provided in a central portion of the disk-form partition wall 50, and hence the first space 12a and second space 12b form a single space.

The disk-form partition wall 50 is disposed between the reduced diameter portion 40 and the second ignition device 30. Axial movement of the disk-form partition wall 50 is limited to the range between the inclined surface portion 42 of the reduced diameter portion 40 and the top surface 35b of the second combustion chamber housing 35.

The disk-form partition wall 50 has a flange portion 51 on a peripheral edge portion. The flange portion 51 pushes against the inner peripheral surface of the cylindrical housing 11, and thus the disk-form partition wall 50 is fitted in the cylindrical housing Next, an operation of the gas generator 100 for an air bag will be described. A case in which the first igniter 22 is activated first and the second igniter 32 is activated at a delay will be described.

Upon activation of the first igniter 22, the first rupturable plate 24 ruptures, causing heat and a shock wave to flow into the first combustion chamber 27 so as to ignite and burn the first molded article of a gas generating composition. High-temperature gas generated through combustion of the first gas generating agent flows into the first space 12a through the gas holes 26 in the first combustion chamber housing 25, thereby raising the pressure of the first space 12a.

The disk-form partition wall 50 is pushed by this increase in the internal pressure of the first space 12a, and hence the disk-form partition wall 50 moves axially until it comes in contact with the top surface 35a of the second combustion chamber housing 35 (FIG. 2(b)). At this time, the communication hole 52 is closed by the top surface 35a.

The increase in the internal pressure of the first space 12a then causes the discharge port rupturable plate 46 to rupture, thereby opening the first gas discharge port 45. A mixed gas including the pressurized gas and high-temperature gas that are ejected through the first gas discharge port 45 moves through the reduced diameter portion 40 in the circumferential direction, passes through the diffuser portion 47, and is discharged radially through the second gas discharge ports 48 to inflate the air bag. During this process, the high-temperature gas flowing out of the first combustion chamber 27 is prevented from igniting and burning the second molded article of a gas generating composition by the disk-form partition wall 50.

The second igniter 32 is activated at a slight delay, thereby rupturing the second rupturable plate 34. Heat and a shock wave then flow into the second combustion chamber 37 to ignite and burn the second molded article of a gas generating composition. The high-temperature gas that is generated through combustion of the second molded article of a gas generating composition flows into the second space 12b through the gas holes 36 in the second combustion chamber housing 35, thereby raising the pressure of the second space 12b.

The disk-form partition wall 50 is pushed by this increase in the internal pressure of the second space 12b, and hence the disk-form partition wall 50 moves axially until it returns to the state shown in FIG. 2(a). As a result, the communication hole 52 is opened, and therefore the mixed gas of pressurized gas and high-temperature gas in the second space 12b passes through the first space 12a, then passes through the open first gas discharge port 46, and is finally discharged radially through the second gas discharge ports 48 to further inflate the air bag.

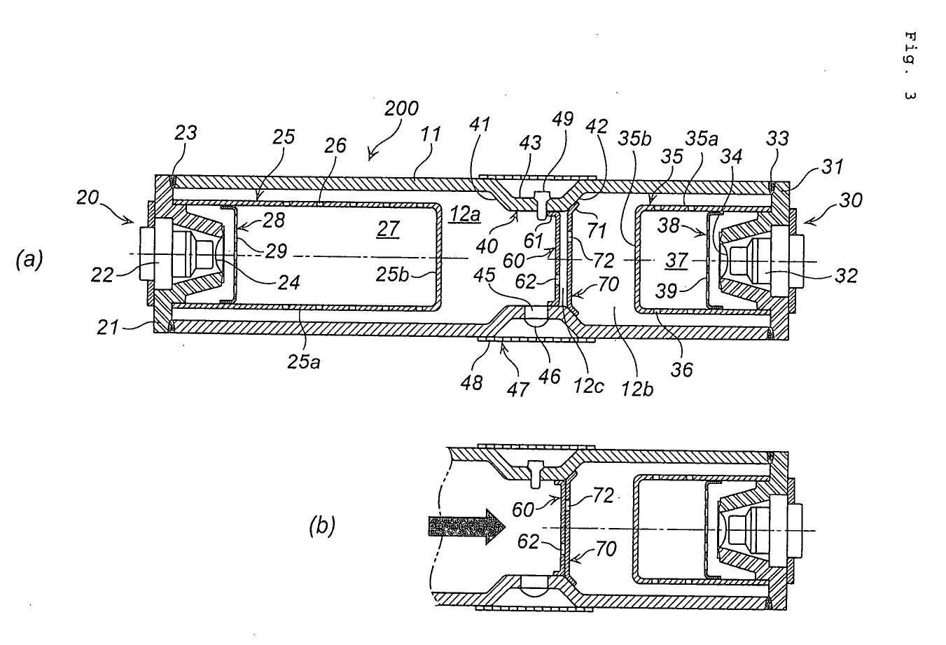

(3) Gas Generator of FIG. 3

FIG. 3(a) is an axial sectional view of a gas generator 200 of the present invention, and FIG. 3(b) is a partial sectional view illustrating an operation of the gas generator 200 in FIG. 3(a). FIG. 3 illustrates a similar structure to the gas generator 10 in FIG. 1, and therefore only different parts will be described. In FIG. 3, identical reference numerals to those used in FIG. 1 denote identical components.

Prior to activation, the interior of the cylindrical housing 11 is partitioned by an axially movable first partition wall 60 and a fixed second partition wall 70 into a first space 12a formed by the first partition wall 60 and cylindrical housing 11, a second space 12b formed by the second partition wall 70 and cylindrical housing 11, and a third space 12c formed by the first partition wall 60, second partition wall 70, and cylindrical housing 11.

The first partition wall 60 takes a disk-form and has a flange portion 61 on a peripheral edge portion. The flange portion 61 pushes against the inner peripheral surface (the flat contour portion 43 of the reduced diameter portion 40) of the cylindrical housing 11, and thus the first partition wall 60 is fitted in the cylindrical housing 11. A circular first communication hole 62 is provided in a part of the first partition wall 60.

The second partition wall 70 takes a disk-form and has a flange portion 71 on a peripheral edge portion. The second partition wall 70 is fixed to the inclined surface portion 42 of the reduced diameter portion 40 at the flange portion 71 by welding. A circular second communication hole 72 is provided in a part of the second partition wall 70.

The pin 49 closing the gas charging hole protrudes from the flat contour portion 43 and thus serves as a stopper portion. As a result, axial movement of the first partition wall 60 is limited to the range between the pin 49 and the second partition wall 70. The length of the pin 49 is adjusted such that the gas charging hole can be closed and axial movement of the first partition wall 60 can be prevented.

The first communication hole 62 in the first partition wall 60 and the second communication hole 72 in the second partition wall 70 are formed in positions such that they do not overlap axially. Hence, when the first partition wall 60 comes in contact with the second partition wail 70, the first communication hole 62 comes in contact with a wall surface of the second partition wall 70 and the second communication hole 72 comes in contact with a wall surface of the first partition wall 60. As a result, both the first communication hole 62 and second communication hole 72 are closed.

Next, an operation of the gas generator 200 for an air bag will be described. A case in which the first igniter 22 is activated first and the second igniter 32 is activated at a delay will be described.

Upon activation of the first igniter 22, the first rupturable plate 24 ruptures, causing heat and a shock wave to flow into the first combustion chamber 27 so as to ignite and burn the first molded article of a gas generating composition. High-temperature gas generated through combustion of the first gas generating agent flows into the first space 12a through the gas holes 26 in the first combustion chamber housing 25, thereby raising the pressure of the first space 12a.

The first partition wall 60 is pushed by this increase in the internal pressure of the first space 12a, and hence the first partition wall 60 moves axially until it comes in contact with the second partition wall 70, thereby eliminating the third space 12c (FIG. 3(b)). At this time, the first communication hole 62 and second communication hole 72 are closed in the manner described above.

The increase in the internal pressure of the first space 12a then causes the discharge port rupturable plate 46 to rupture, thereby opening the first gas discharge port 45. A mixed gas including the pressurized gas and high-temperature gas that are ejected through the first gas discharge port 45 moves through the reduced diameter portion 40 in a circumferential direction, passes through the diffuser portion 47, and is discharged radially through the second gas discharge ports 48 to inflate the air bag. During this process, the high-temperature gas flowing out of the first combustion chamber 27 is prevented from igniting and burning the second gas generating agent by the first partition wall 60 and second partition wall 70.

The second igniter 32 is activated at a slight delay, thereby rupturing the second rupturable plate 34. Heat and a shock wave then flow into the second combustion chamber 37 to ignite and burn the second molded article of a gas generating composition. The high-temperature gas that is generated through combustion of the second molded article of a gas generating composition flows into the second space 12b through the gas holes 36 in the second combustion chamber housing 35, thereby raising the pressure of the second space 12b.

By applying the pressure in the second space 12b on the portion of the first partition wall 60 corresponding to the second communication hole 72, the first partition wall is pushed by the internal pressure and hence the first partition wall 60 moves axially. The first partition wall 60 stops moving when it comes in contact with the pin 49, and is thus returned to the state shown in FIG. 3(a) with the third space 12c restored. As a result, the first communication hole 62 and second communication hole 72 are opened, and therefore the mixed gas of pressurized gas and high-temperature gas in the second space 12b passes through the third space 12c and first space 12a, then passes through the open first gas discharge port 46, and is finally discharged radially through the second gas discharge ports 48 to further inflate the air bag.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator for an air bag, comprising a single cylindrical housing charged with a pressurized gas and at least one ignition device mounted to the cylindrical housing,
the cylindrical housing having a reduced diameter portion formed by an annular convex portion protruding inward,
the reduced diameter portion having a single first gas discharge port sealed by a rupturable plate,
the reduced diameter portion, which has the first gas discharge port, being surrounded by a cylindrical diffuser portion having a plurality of second gas discharge ports, and
an outer diameter, which includes the part surrounded by the diffuser portion, approximating an outer diameter of the cylindrical housing.

2. The gas generator for an air bag according to claim 1, wherein, when two or more ignition devices are provided, at least one of the ignition devices accommodates, in a combustion housing having a plurality of the gas discharge ports, a gas generating agent and an electric igniter.

3. The gas generator for an air bag according to claim 1, further comprising:
the cylindrical housing being partitioned into two spaces by an axially movable partition wall having a communication hole,
at least a first activated ignition device and a second activated ignition device being disposed in each of the two spaces, respectively
the partition wall moving in the axial opposite direction to the first activated ignition device, upon the activation of the ignition device disposed in one of the spaces, so as to close a communication hole by coming into contact with a part of a fixing member disposed in the other space,
the partition wall moving in the axial opposite direction to the second activated ignition device, upon the activation of the second activated ignition device disposed in the other space, so as to open the communication hole.

4. The gas generator for an air bag according to claim 3, wherein the partition wall is disposed between the reduced diameter portion of the cylindrical housing and the second activated ignition device.

5. The gas generator for an air bag according to claim 3, wherein the second activated ignition device accommodates, in a combustion chamber housing having a plurality of gas holes, a gas generating agent and an electric igniter,
the combustion chamber housing is the fixed member, and
the partition wall comes in contact with a wall surface of the combustion chamber housing having no gas holes.

6. The gas generator for an air bag according to claim 1, further comprising:
an axially movable first partition wall having a first communication hole and a fixed second partition wall having a second communication hole partitioning the cylindrical housing into a first space formed by the first partition wall and the cylindrical housing, a second space formed by the second partition wall and the cylindrical housing, and a third space formed by the first partition wall, the second partition wall and the cylindrical housing,
the first communication hole of the first partition wall and the second communication hole of the second partition wall being formed in positions which do not overlap axially,
at least one first ignition device and second ignition device being disposed in the first space and the second space, respectively,
when the first ignition device disposed in the first space is activated, the first partition wall moving toward an axially opposite side, and when the first partition wall comes in contact with the second partition wall, the first communication hole and the second communication hole being closed, and
when the at least one second ignition device, which is disposed in the second space, being activated, the first partition wall, which contacts the second partition wall, moving toward an axially opposite side to the second partition wall, thereby opening the first communication hole and the second communication hole.

7. The gas generator for an air bag according to claim 6, wherein the reduced diameter portion of the cylindrical housing is an annular convex portion protruding inward which has two axially opposing inclined surface portions and a flat contour portion provided between the two inclined surface portions,
the first partition wall is disposed on the flat contour portion of the reduced diameter portion, the flat surface portion having a stopper portion for restricting axial movement of the first partition wall, and
the second partition wall is fixed to one of the inclined surface portions of the reduced diameter portion.

8. A gas generator, comprising:
a single cylindrical housing including a first open end and a second open end and being charged with a pressurized gas therein;
a first ignition device attached to the first open end and a second ignition device attached to the second open end;
an reduced diameter portion formed in a circumference of the single cylindrical housing between the first open end and the second open end and protruding inwardly;
a single first gas discharge port provided in the reduced diameter portion and being closed by a rupturable plate; and
a diffuser portion having a plurality of second gas discharge ports and being provided around the reduced diameter portion such that the gas generator has a substantially flat contour line in the axial direction thereof.

9. A gas generator according to claim 8, further comprising:
a first partition wall provided within the single cylindrical housing such that the partition wall moves in an axial direction of the single cylindrical housing when the first ignition device and the second ignition device are activated, respectively, the first partition wall partitioning an interior of the single cylindrical housing into at least a fist space and a second space.

10. A gas generator according to claim 8, further comprising:
a first hole provided in the first partition wall and communicating the first space with the second space; and
a second ignition device housing including therein the second ignition device and fixed within the second space,
wherein the first hole is closed by moving the first partition wall and coming in contact with the second ignition device housing when the first ignition device is activated and opened when the first partition wall leaves the second ignition device housing following activation of the second ignition device.

11. A gas generator according to claim 9, further comprising:
a second partition wall fixed within the single cylindrical housing between the first partition wall and the second ignition device, and defining a second space including a second ignition device and a third space between the first partition wall and the second partition wall, the second partition wall including a second hole formed such that the first hole and the second hole do not coincide with each other,
wherein the first hole is closed by moving the first partition wall and coming in contact with the second partition wall when the first ignition device is activated, and opened when the first partition wall leaves the second partition wall following activation of the second ignition device.
